(19) United States
(12) Patent Application Publication
(10) Pub. No.: US 2005/0055408 A1
(43) Pub. Date: Mar. 10, 2005

(54) System, device and method for sending a message at a predetermined time

(76) Inventor: Zhu Dong, Vaerloese (DK)

Correspondence Address: PERMAN & GREEN, 425 POST ROAD, FAIRFIELD, CT, 06824, US

(21) Appl. No.: 10/658,568

(22) Filed: Sep. 9, 2003

(51) Int. Cl. G06F 15/16

(52) U.S. Cl. 709/206; 709/230

(57) ABSTRACT

This invention relates to a system, device and method for sending a message at a predetermined time. In particular, this invention relates to a mobile communication device, such as a cell or mobile telephone, enabling generation of a message to be transmitted at a predetermined time. It is an object of the present invention that the system, device and method are capable of transmitting a message or notification at any give predetermined time.

### FIELD OF INVENTION

This invention relates to a system, device and method for sending a message at a predetermined time. In particular, this invention relates to a mobile communication device, such as a cell or mobile telephone, enabling generation of a message to be transmitted at a predetermined time.

### BACKGROUND OF INVENTION

Within the technology of personal digital assistants information managing systems are known to provide notifications regarding calendar events. The notifications are generally established onboard each personal digital assistant or entered into each personal digital assistant through a synchronization process run by a connecting personal computer.

American patent no. U.S. Pat. No. 6,208,996 discloses a system for maintaining a notification database in a personal digital assistant having a notification scheduling application running at a predetermined time and configured to obtain information indicative of a plurality of notifications to be presented in the future. The notifications which are to be presented within a predetermined time period are recorded in the notification database. Thus the personal digital assistant continuously requires updating of the notification database prior to expiry of the predetermined time period in order to avoid that some notifications are missed. Further, each personal digital assistant connecting to the personal computer requires the notification scheduling application stored onboard in local memory.

### SUMMARY OF THE INVENTION

An object of the present invention is therefore to provide a system and method capable of transmitting a message or notification at any give predetermined time.

A particular advantage of the present invention is provision of transmission of messages which may be received at one or more mobile communication devices connected in a telecommunication network.

A further advantage of the present invention is provision of a predetermined timing application implemented in a transmitting mobile communication device thus avoiding the requirement for implementations of predetermined timing applications on receiving mobile communication devices.

The above object and advantages together with numerous other objects, advantages and features, which will become evident from below detailed description, are obtained according to a first aspect of the present invention by a system for transmitting a message at a predetermined time and comprising a transmitting mobile communication device connected to a communication network, and said transmitting mobile communication device comprising a message generator enabling an operator of said transmitting mobile communication device to generate a message and to define a recipient of said message and a predetermined time for transmitting said message, and a timing element transmitting said message at said predetermined time.

A message should in this context be construed as a package containing information to be forwarded through a communication network. The package may contain notifications or alerts and may contain text, audio tracks as well as visual images. The message may be configured as a short messaging service (SMS) or multimedia messaging service (MMS) message or may in fact be configured as unstructured supplementary service data (USSD).

The communication network according to the first aspect of the present invention may comprise a wireless telecommunication network, a wireless short range short wave radio network, such as Bluetooth, a computer network, or any combination thereof. Generally the mobile communication device connects through a wireless telecommunication network, however, the mobile communication device may connect to any of the above communication networks or the communication network may be any combination of a wireless telecommunication network, Bluetooth network and a computer network. In fact, the communication network may further comprise a television network connecting to a telecommunication or Bluetooth gateway.

The transmitting mobile communication device according to the first aspect of the present invention may further comprise a calendar element enabling the operator to schedule events, which calendar element may connect to the message generator and to the timing element thereby enabling the operator to define an event in the calendar element and to generate a message comprising an event notification and to define a predetermined time for transmitting the message to a receiving mobile communication device requested to participate in the event. The calendar element provides great advantages over prior art since the receiving mobile communication device does not require any further specific application to receive the message.

The above object and advantages together with numerous other objects, advantages and features, which will become evident from below detailed description, are obtained according to a second aspect of the present invention by a mobile communication device for connecting to a communication network and transmitting a message at a predetermined time, and comprising a keyboard and display for interfacing with an operator, a storage element for storing a message generator application adapted to enable said operator to generate content of said message, a transmission application adapted to process and pass said message, and a timing application adapted to time transmission of said message according to a predetermined transmission time, a processor for processing data and executing said applications stored in said storage element.

The message generator application enables the operator to firstly generate content of the message and secondly set the message parameters such as recipient or recipients of the message and the transmission time. The message generator application calls the transmission application for preparing the transmission through the message handling element, which during the process calls the timing application, so as to start the timing function determining the transmission time of the message.

The transmission application according to the second aspect of the present invention may further operate a message handling element handling transmission of said message through said communication network. The handling element is a hardware component operated by the processor through applications run on the mobile communication device.

The mobile communication device according to the second aspect of the present invention may further comprise a calendar application adapted to enable the operator to perform calendar operations. The calendar application may call the message generator application for generating a notification to be transmitted in the message at the predetermined time. Hence the operator of the mobile communication device may, firstly, use the calendar application for sending a message requesting a receiving mobile communication device to attend an event and may, secondly, remind the receiving mobile communication device by using the message generator application to generate a notification as a message to be forwarded at a predetermined time.

The mobile communication device according to the second aspect of the present invention may comprise any features described with reference to the system according to the first aspect of the present invention.

The above object and advantages together with numerous other objects, advantages and features, which will become evident from below detailed description, are obtained according to a fourth aspect of the present invention by a method for transmitting a message at a predetermined time from a transmitting mobile communication device connected to a communication network, and said method comprising,
(a) storing in a storage element a message generator application, a transmission application, and a timing application,
(b) processing data and executing said applications stored in said storage element by means of a processor,
(c) enabling said operator to generate content of said message by means of said message generator application interfacing with said operator through a display and keyboard,
(d) enabling said operator to define a recipient of said message and a predetermined time for transmitting said message to said recipient,
(e) processing and passing said message by means of said transmission application,
(f) timing transmission of said message according to said predetermined transmission time by means of said timing application,
(g) transmitting said message through said communication network at said predetermined time by means of a message handling element operable by said transmission application.

The method according to the third aspect of the present invention may comprise any features described with reference to the system according to the first aspect of the present invention or the mobile communication device according to the second aspect of the present invention.

The above object and advantages together with numerous other objects, advantages and features, which will become evident from below detailed description, are obtained according to a third aspect of the present invention by a computer program comprising code adapted to perform the following when said program is run on a processor:
(a) storing in a storage element a message generator application, a transmission application, and a timing application,
(b) processing data and executing said applications stored in said storage element by means of said processor,
(c) enabling an operator to generate content of said message by means of said message generator application interfacing with said operator through a display and keyboard,
(d) enabling said operator to define a recipient of said message and a predetermined time for transmitting said message to said recipient,
(e) processing and passing said message by means of said transmission application,
(f) timing transmission of said message according to said predetermined transmission time by means of said timing application, and
(g) transmitting said message through a communication network at said predetermined time by means of a message handling element operable by said transmission application.

The computer program according to the fourth aspect of the present invention may comprise any features described with reference to the system according to the first aspect of the present invention, the mobile communication device according to the second aspect of the present invention, or the method according to the third aspect of the present invention.

### BRIEF DESCRIPTION OF THE DRAWINGS

The above, as well as additional objects, features and advantages of the present invention, will be better understood through the following illustrative and non-limiting detailed description of a preferred embodiment of the present invention, with reference to the appended drawing, wherein:

FIG. 1, shows an exploded view of a mobile communication device according to a preferred embodiment of the present invention; and

FIG. 2, shows a schematic interactions/flow chart of the preferred implementation of the present invention.

### DETAILED DESCRIPTION OF PREFERRED EMBODIMENTS

In the following description of the various embodiments, reference is made to the accompanying drawing, which forms a part hereof, and in which is shown by way of illustration an embodiment in which the invention may be practiced. It is to be understood that other embodiments may be utilized, and structural and functional modifications may be made without departing from the scope of the present invention.

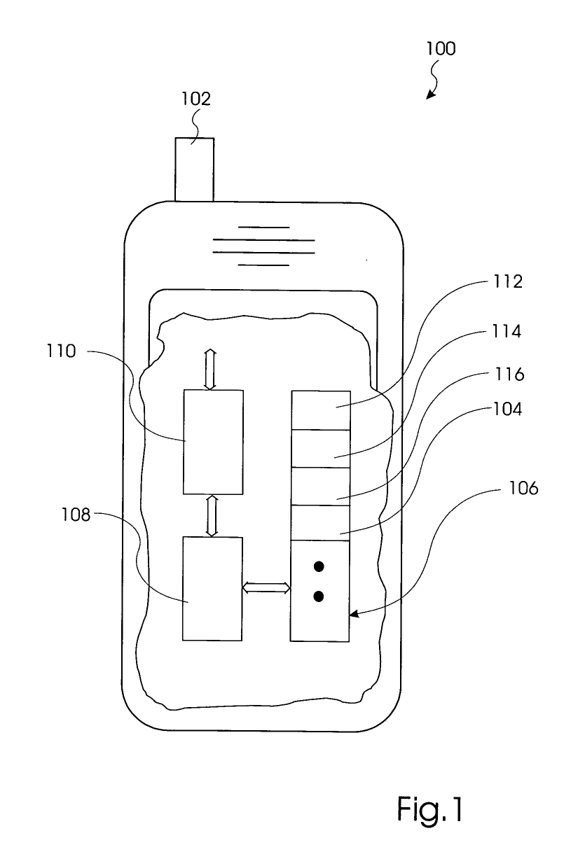

FIG. 1, shows an exploded view of a mobile communication device designated in entirety by reference numeral 100. The mobile communication device 100 is shown in FIG. 1 as a cell or mobile telephone but may in alternative embodiments comprise a personal digital assistant or a computer. The mobile communication device 100 connects to a communication network through an antenna 102. The communication network may comprise a wireless telecommunication network, a short range short wave radio network (Bluetooth) a wireless computer network or any combination thereof.

The mobile communication device 100 comprises a storage element 106 for storing applications activated by an operator of the mobile communication device 100 or activated by a service provider of the communication network. The mobile communication device 100 further comprises a processor 108 for processing data and executing the applications stored in the storage element 106. In addition, the mobile communication device 100 comprises a message handling element 110 for handling transmission and reception of messages through the communication network.

The term “message” should in this context be construed as a short messaging services (SMS) text message or a multimedia messaging services (MMS) message. Further, the term “message” should be construed as comprising unstructured supplementary service data (USSD).

The mobile communication device 100, according to the preferred embodiment of the present invention, further in the storage element 106 comprises a message transmission application 112 providing a user interface to the operator of the mobile communication device 100, in which the operator may select recipients of a message, and enabling the operator to transmit a message to the communication network. The mobile communication device 100 further comprises a calendar application 114 providing a calendar user interface to the operator of the mobile communication device 100 and enabling the operator calendar facilities, and comprises a timing application 116 for managing timing of transmission of messages generated by the operator.

During generation of a message the operator is requested to input the required transmission time, at which the message is to be transmitted to one or more recipients. This functionality provides great advantages over known techniques, since it is implemented entirely on the transmitting mobile communication device 100 and not potential receiving mobile communication devices connected to the communication network. Thus the preferred embodiment is fully backward compatible.

The operator may generate a message by using a message generator application 104 providing a user interface for entering the message.

The calendar application 114 may in the preferred embodiment of the present invention perform an application call to the message generator application 104 provided the operator wishes to enter a note or remark associated with an appointment in the operator's calendar. Subsequently, to entering the message the operator may enter a predetermined time for initiating a transmission of the message to selected recipients, possibly recipients associated with the appointment in the calendar. The timing application 116 records the operator's selection of transmission time and activates the message handling element 110 to initiate transmission of the message on the predetermined time.

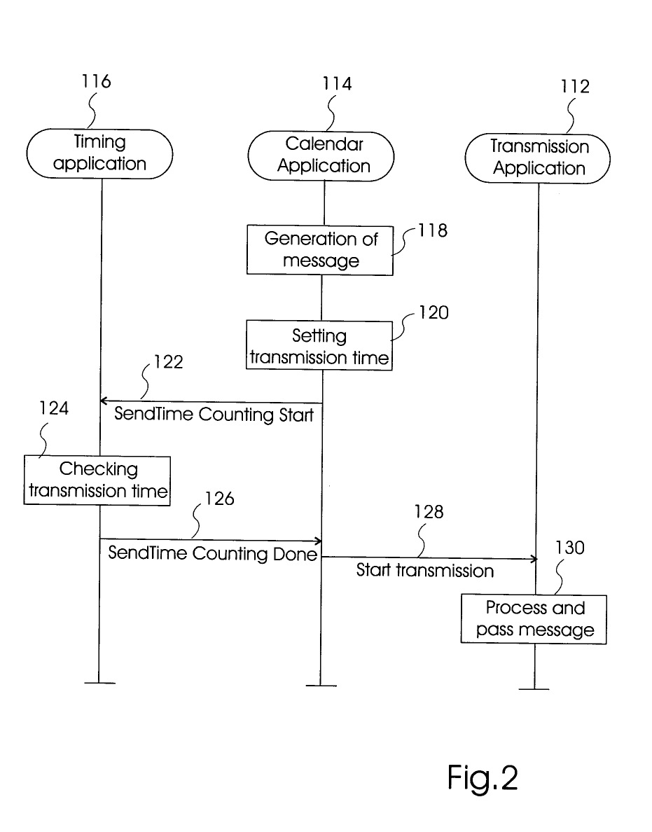

FIG. 2, shows an interactions/flow chart of the system designated in FIG. 1 by reference numeral 100.

As described with reference to FIG. 1, the system 100 comprises a transmission application 112, a calendar application 114, and a timing application 116. The calendar application 114 generates a message 118 by performing an application call to a message generator application 104 or by providing an internal message generator. The calendar application 114 further enables an operator to set a transmission time 120 by entering a time, at which the operator desires the message to be forwarded to one or more mobile communication devices connected to the communication network. Subsequently, to recording a predetermined transmission time the calendar application 114 performs an application call to the timing application 116 and sends a counting start request 122 in order to register the predetermined time in a timing register. The timing application 116 ensures that the timing of the transmission is accomplished by continuously checking the transmission time 124 with an internal clock function. When the timing application 116 has identified a transmission time in the timing register associated with a message which is ready for transmission, the timing application 116 sends a counting done signal 126 to the calendar application 114. The calendar application 114 forwards the message together with a start transmission signal 128 to the transmission application 112 for processing and transmission. The transmission application 112 processes and passes the message 130 onto the message handling element 110 of the mobile communication device 100.

In an alternative embodiment the calendar application 114 may be substituted as well as complimented with a message generator application 104.

1. A system for transmitting a message at a predetermined time and comprising a transmitting mobile communication device connected to a communication network, and said transmitting mobile communication device comprising a message generator enabling an operator of said transmitting mobile communication device to generate a message and to define a recipient of said message and a predetermined time for transmitting said message, and a timing element transmitting said message at said predetermined time.

2. A system according to claim 1, wherein said message comprises a notification or an alert comprising a text, an audio track, a visual image, or any combination thereof.

3. A system according to claim 1, wherein said message comprises a short messaging service (SMS), a multimedia messaging service (MMS) message, or unstructured supplementary service data (USSD).

4. A system according to claim 1, wherein said communication network comprises a wireless telecommunication network, a wireless short range short wave radio network, such as Bluetooth, a computer network, or any combination thereof.

5. A system according to claim 4, wherein said communication network further comprises a television network connecting to a gateway connected to said telecommunication network, said computer network, or said Bluetooth network.

6. A system according to claim 1, wherein said mobile communication device further comprises a calendar element enabling said operator to schedule events, which calendar element connecting to said message generator thereby enabling said operator to define an event in the calendar element and to generate an event notification in said message and to define a predetermined time for transmitting said event notification to said recipient.

7. A mobile communication device for connecting to a communication network and transmitting a message at a predetermined time, and comprising a keyboard and display for interfacing with an operator, a storage element for storing a message generator application adapted to enable said operator to generate content of said message, a transmission application adapted to process and pass said message, and a timing application adapted to time transmission of said message according to a predetermined transmission time, a processor for processing data and executing said applications stored in said storage element.

8. A mobile communication device according to claim 7, wherein said message generator application is adapted to call said transmission application for preparing transmission through said message handling element, which during the process is adapted to call the timing application starting a timing function determining the transmission time of said message.

9. A mobile communication device according to claim 7 further comprising a calendar application adapted to enable the operator to perform calendar operations and wherein said calendar application is adapted to call said message generator application for generating a notification to be transmitted in said message at the predetermined time.

10. A method for transmitting a message at a predetermined time from a transmitting mobile communication device connected to a communication network, and said method comprising,
(a) storing in a storage element a message generator application, a transmission application, and a timing application,
(b) processing data and executing said applications stored in said storage element by means of a processor,
(c) enabling said operator to generate content of said message by means of said message generator application interfacing with said operator through a display and keyboard,
(d) enabling said operator to define a recipient of said message and a predetermined time for transmitting said message to said recipient,
(e) processing and passing said message by means of said transmission application,
(f) timing transmission of said message according to said predetermined transmission time by means of said timing application,
(g) transmitting said message through said communication network at said predetermined time by means of a message handling element operable by said transmission application.

11. A computer program comprising code adapted to perform the following when said program is run on a processor:
(a) storing in a storage element a message generator application, a transmission application, and a timing application,
(b) processing data and executing said applications stored in said storage element by means of said processor,
(c) enabling an operator to generate content of said message by means of said message generator application interfacing with said operator through a display and keyboard,
(d) enabling said operator to define a recipient of said message and a predetermined time for transmitting said message to said recipient,
(e) processing and passing said message by means of said transmission application,
(f) timing transmission of said message according to said predetermined transmission time by means of said timing application, and
(g) transmitting said message through a communication network at said predetermined time by means of a message handling element operable by said transmission application.
